(19) United States
(12) Patent Application Publication
(10) Pub. No.: US 2007/0094686 A1
(43) Pub. Date: Apr. 26, 2007

(54) Apparatus for setting mood mode and transforming images and method of setting mood mode and transforming images

(75) Inventors: Deok-ho Kim, Seoul (KR); Nam-soon Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/585,123

(22) Filed: Oct. 24, 2006

(30) Foreign Application Priority Data
Oct. 25, 2005 (KR) 10-2005-0100844

(51) Int. Cl. G06F 13/00; G06F 3/00; H04N 5/445

(52) U.S. Cl. 725/45; 725/46

(57) ABSTRACT

A method and apparatus are provided for setting a mood mode and transforming images. The apparatus for setting a mood mode includes an image supplying unit supplying images, a setting unit setting a mood mode for the supplied images, and a storing unit storing a setting value of the mood mode in mood information data of each of the images.

### CROSS-REFERENCE TO RELATED APPLICATION

This application claims priority from Korean Patent Application No. 10-2005-0100844 filed on Oct. 25, 2005 in the Korean Intellectual Property Office, the disclosure of which is incorporated herein by reference in its entirety.

### BACKGROUND OF THE INVENTION

1. Field of the Invention

Apparatuses and methods consistent with the present invention relate to setting a mood mode and transforming images, and more particularly, to setting a mood mode and transforming images, wherein which moods to can be expressed in images.

2. Description of the Related Art

Recently, due to the widespread use of devices such as digital cameras and cellular phones having cameras mounted therein, attempts have been capture everyday moments with the cameras.

Generally, when pictures are taken by a camera, a user desires not only to capture background images at that time but also to remain a mood at the moment. However, after a certain amount of time has passed, it is often difficult to remember the moods at the moment when the pictures were taken. In addition, when the users want to view pictures of good moments, they should find the pictures one by one to see what they want.

### SUMMARY OF THE INVENTION

The present invention provides an apparatus and method for setting a mood mode and transmitting images.

According to an aspect of the present invention, there is provided an apparatus for setting a mood mode, the apparatus including an image supplying unit supplying images, a setting unit setting a mood mode for the supplied images, and a storing unit storing a setting value of the mood mode in mood information data of each of the images.

According to another aspect of the present invention, there is provided an apparatus for transforming images, the apparatus including a searching unit searching for a display effect according to a mood mode set for images, a transforming unit transforming the images according to the found display effect, and an outputting unit outputting the transformed images.

According to still another aspect of the present invention, there is provided a method for setting a mood mode, the method including supplying images, setting a mood mode for the supplied images, and storing a setting value of the mood mode in mood information data of each of the images.

According to yet another aspect of the present invention, there is provided a method for transforming images, the method including searching for a display effect according to a mood mode set for images, transforming the images according to the found display effect, and outputting the transformed images.

### BRIEF DESCRIPTION OF THE DRAWINGS

The above and other aspects of the present invention will become more apparent by describing in detail exemplary embodiments thereof with reference to the attached drawings, in which:

FIG. 1 is a view illustrating a concept in which moods are expressed in images in accordance with an exemplary embodiment of the present invention;

FIG. 2 is a view illustrating a construction in which moods are expressed in images in accordance with another exemplary embodiment of the present invention;

FIG. 3 is a block diagram of an apparatus for setting a mood mode in accordance with still another exemplary embodiment of the present invention;

FIG. 4 illustrates a structure of mood information data including the mood mode setting value according to yet another exemplary embodiment of the present invention;

FIG. 5 is a block diagram of an apparatus for transforming images in accordance with an exemplary embodiment of the present invention;

FIG. 6 is a flowchart illustrating a method of setting a mood mode in accordance with another exemplary embodiment of the present invention;

FIG. 7 is a flowchart illustrating a method of transforming images in accordance with still another exemplary embodiment of the present invention;

FIGS. 8A and 8B illustrate a mood mode setting menu in accordance with yet another exemplary embodiment of the present invention;

FIG. 9 illustrates a method of applying a display effect to images in accordance with an exemplary embodiment of the present invention;

FIGS. 10A, 10B and 10C illustrate images being output according to a mood category in accordance with another exemplary embodiment of the present invention; and

FIGS. 11A and 11B illustrate a construction of a mood category group in accordance with still another exemplary embodiment of the present invention.

### DESCRIPTION OF THE EXEMPLARY EMBODIMENTS

Advantages and features of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

The present invention will now be described more fully with reference to the accompanying drawings, in which exemplary embodiments of the invention are shown.

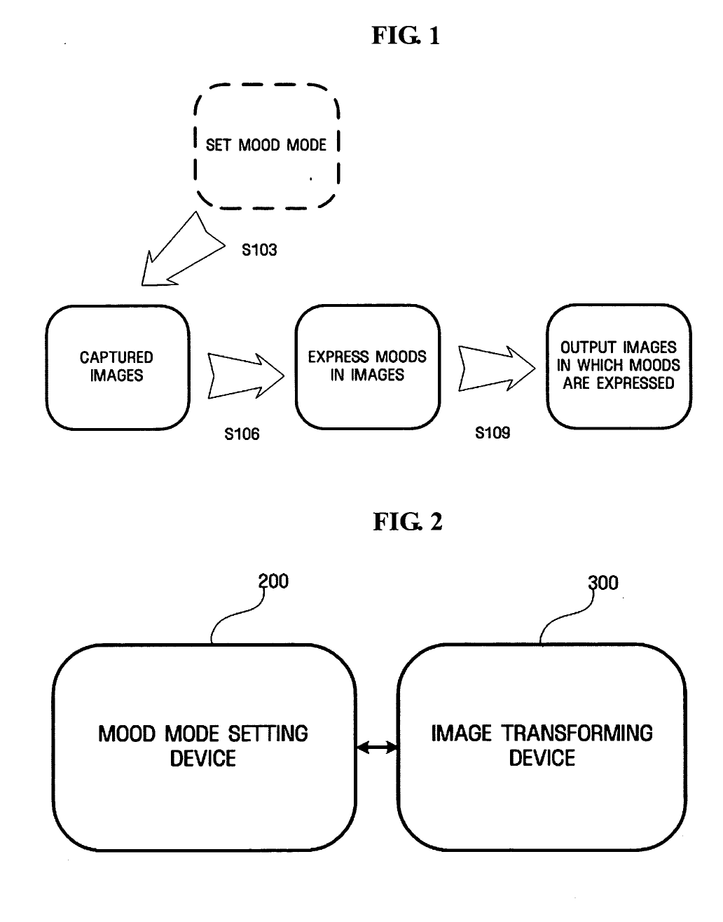

FIG. 1 is a view illustrating a concept that moods are expressed in images in accordance with an exemplary embodiment of the present invention.

When supplied with images captured by a user or images transmitted by other capturing devices or image acquiring devices, the user can edit the images as desired by controlling colors, brightness, sharpness and the like. Generally, if the user feels good, the user may set a bright color with high sharpness. If the user feels bad or angry, the user may set a dark color with low sharpness.

First, the user sets a predetermined mood mode for the supplied images according to user's mood (S103). The mood mode may be set before or after images are captured.

Various effects are applied to the captured images according to the mood mode set for the captured images, and the images in which moods are expressed are output (S106 and S109).

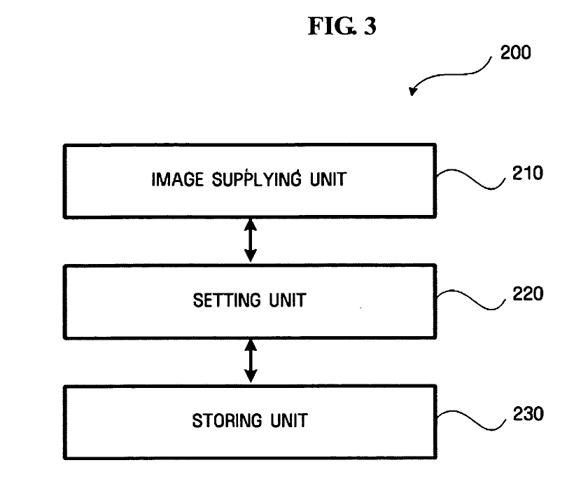

FIG. 2 is a view illustrating a construction in which moods are expressed in images in accordance with another exemplary embodiment of the present invention.

A mood mode setting device 200 and an image transforming device 300 are provided in order to express moods in images.

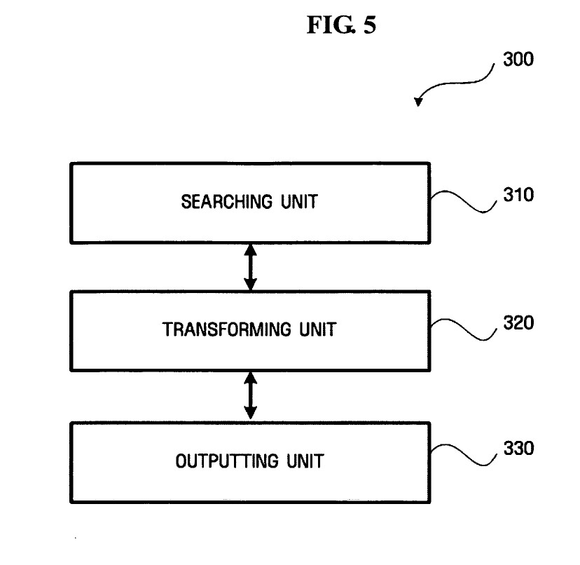

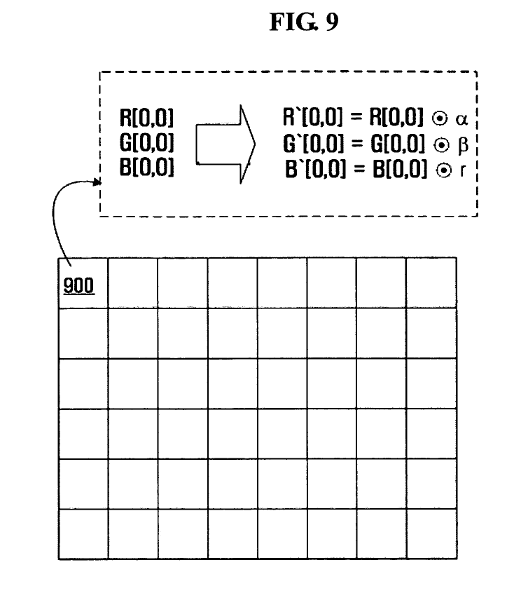

The mood mode setting device 200 is supplied with images captured by a user or images transmitted by other capturing devices or image acquiring devices, and sets a desired mood mode for corresponding images. Here, the mood mode may be set before or after the images are supplied. A mood mode setting menu 800 will be described below with reference to FIG. 8. The set mood mode is stored as mood information data 400. The mood information data 400 may be included in an image file. The mood information data 400 will be described below with reference to FIG. 4.

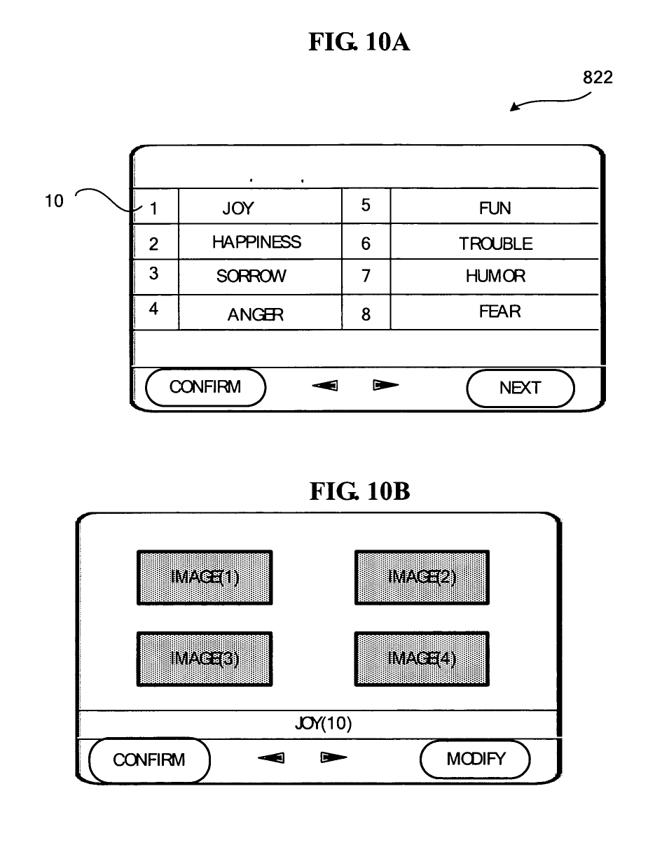

The image transforming device 300 applies a display effect that matches the set mood mode to the images, transforms the corresponding images, and outputs the transformed images. It may be preferable that the display effect be previously set, and it is possible for the user to change the display effect to another through a predetermined control menu. A method of applying a display effect to images will be described below with reference to FIG. 9.

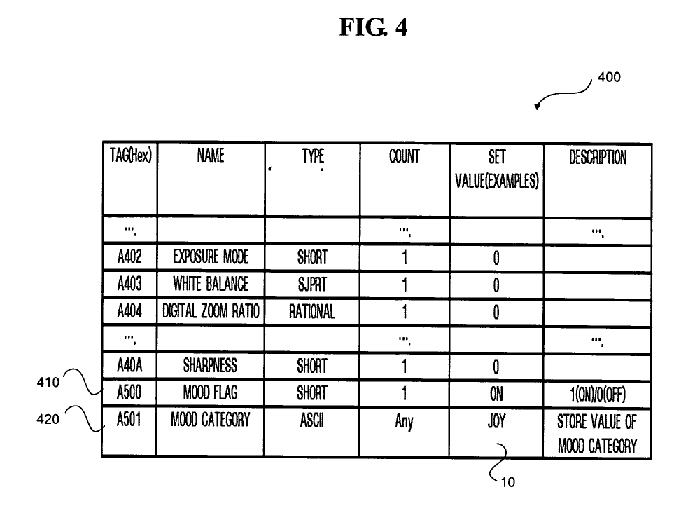

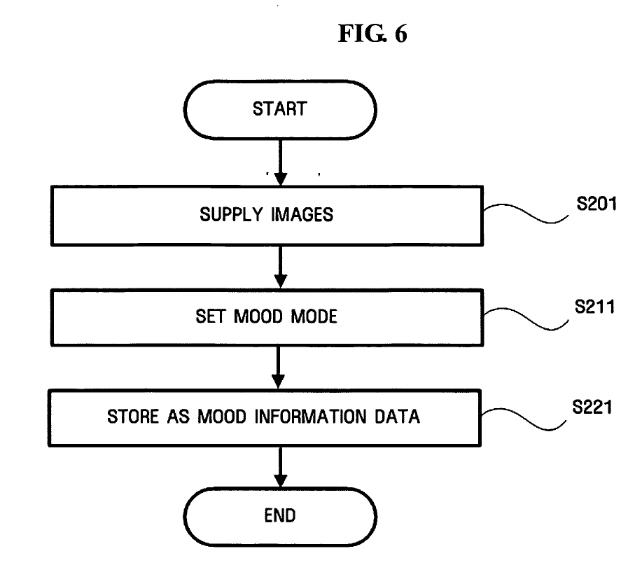

In this case, the mood mode setting device 200 and the image transforming device 300 may interlock with each other. One apparatus may include a function of the other apparatus. For example, the image transforming device 300 may apply a display effect matching with the mood mode set by the mood mode setting device 200. In addition, the image transforming device 300 may be configured to have a mood mode setting function of the mood mode setting device 200, such that the image transforming device 300 may directly apply a display effect that matches the set mood mode and transform the images. Similarly, the mood mode setting device 200 may be configured to have both transforming and outputting functions of the image transforming device 300. Therefore, the mood mode setting device 200 may transform images and output the transformed images after applying a display effect that matches the mood mode to the supplied images. Hereinafter, with reference to FIGS. 3 and 5, the mood mode setting device 200 and the image transforming device 300 will be described.

FIG. 3 is a block diagram of a mood mode setting device in accordance with still another exemplary embodiment of the present invention.

The mood mode setting device 200 includes an image supplying unit 210, a setting unit 220 and a storing unit 230.

The image supplying unit 210 supplies images. The images may be captured by the user or transmitted by other capturing devices or image acquiring devices. It may be preferable that the images be supplied in a particular file format. Here, the mood information data 400 may be included in an image file. The mood information data 400 will be described below with reference to FIG. 4.

The setting unit 220 sets a mood mode, desired by the user, for the supplied images. The user is provided with a mood flag menu 810 and a mood category menu 820, which will be described below with reference to FIGS. 8A and 8B, in order to set a mood mode. The mood mode may be set before or after images are supplied. The set value is input as information regarding the mood information data 400.

The storing unit 230 stores the setting value of the mood mode set by the setting unit 220 as the mood information data 400 of each of the corresponding images.

FIG. 4 illustrates a structure of mood information data including the setting value of the mood mode according to yet another exemplary embodiment of the present invention.

Images supplied by the image supplying unit 210 are stored in a file format. The image file may include the mood information data 400. The mood information data 400 may be exchangeable image file (Exif) information data in the form of meta data. The mood information data 400 includes a mood flag tag 410 and a mood category tag 420. The mood flag tag 410 and the mood category tag 420 receive data of setting values of the mood mode setting menu 800, and store the received data in the storing unit 230.

The mood flag tag 410 determines whether or not to apply a display effect to corresponding images according to a set value. If the mood flag tag 410 is turned on through the mood flag menu 810 of the mood mode setting menu 800, the mood flag tag 410 applies a display effect to the corresponding images through a transforming unit 320 to convert the images. If the mood flag tag 410 is turned off, the mood flag tag 410 outputs original images through an outputting unit 330.

The mood category tag 420 includes a mood category 822 as a set value through the mood category menu 820 of the mood mode setting menu 800. The mood category 822 may include any one form of text, icons, and moving or still images.

FIG. 5 is a block diagram of an image transforming device in accordance with an exemplary embodiment of the present invention.

The image transforming device 300 includes a searching unit 310, a transforming unit 320 and an outputting unit 330.

The searching unit 310 searches for a display effect that matches the mood category 822, among setting values of a mood mode set by the user through the setting unit 220. Here, the mood category 822 of the setting values of the mood mode may be set through the mood category menu 820, and the set value is stored in the mood category tag 420. Accordingly, the searching unit 310 searches for a display effect that matches the stored value (set value).

The transforming unit 320 applies the display effect that matches the setting value of the mood category tag 420 found by the searching unit 310, to the corresponding images through a predetermined operation. A method of transforming images by applying a display effect to corresponding images will be described below with reference to FIG. 9.

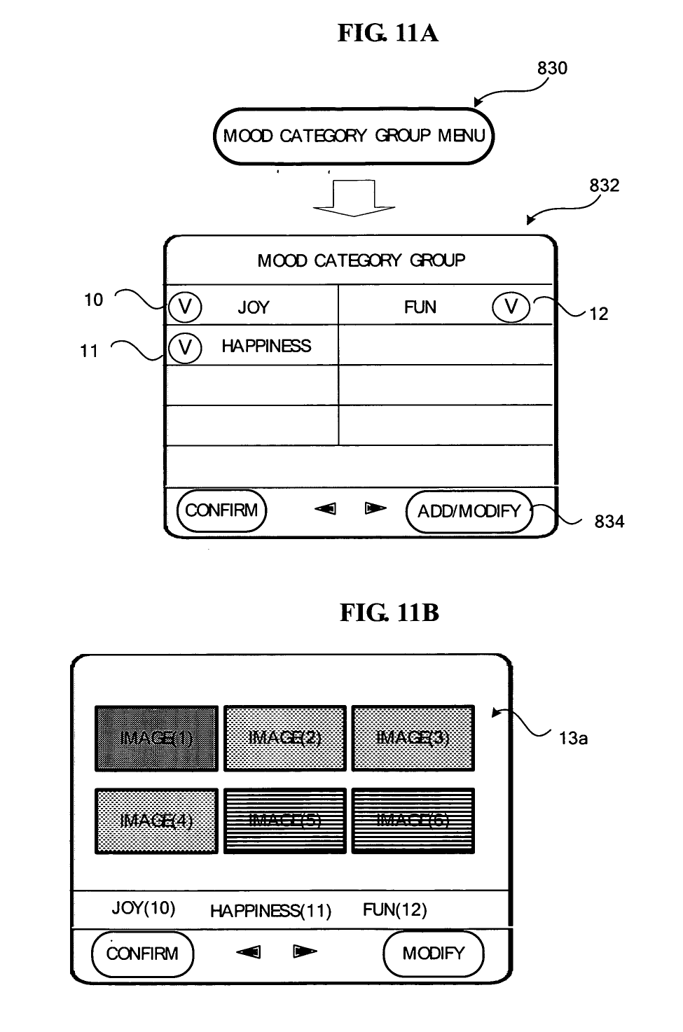

The outputting unit 330 outputs the images transformed by the transforming unit 320 according to the mood category 822. Images of a mood category group 832, to which the mood category 822 selected by the user belongs, may be gathered together and output. An exemplary embodiment in which images of the mood category group 832 are gathered together and output will be described with reference to FIGS. 11A and 11B.

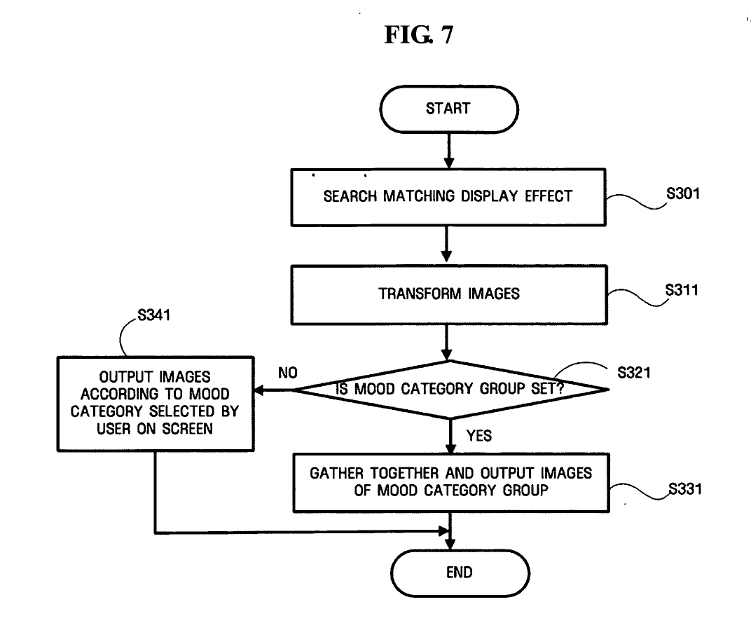

FIG. 6 is a flowchart illustrating a method of setting a mood mode in accordance with another exemplary embodiment of the present invention.

Images, which may be captured by the user or transmitted by other capturing devices or image acquiring devices, are supplied (S201).

The user sets a mood mode for the images supplied through the setting unit 220 (S211). The mood mode can be set through the mood mode setting menu 800 and may be set before or after the images are supplied.

The set mood mode is stored as the mood mode data 400 in the storing unit 230 (S221).

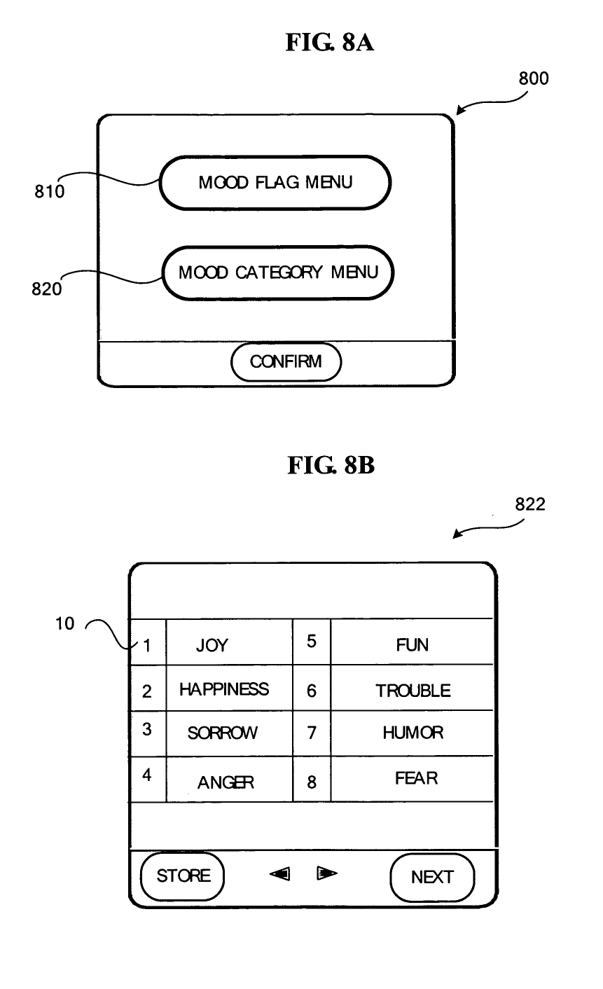

FIG. 7 is a flowchart illustrating a method of transforming images in accordance with still another exemplary embodiment of the present invention.

The setting value of the mood mode set by the user through the setting unit 220 is stored as the mood information data 400. The searching unit 310 searches for a display effect that matches the setting value of the mood category tag 420 among the mood information data 400 (S301). Here, the setting value of the mood category tag 420 is a value of the mood category 822 which is set through the mood category menu 820 of the mood mode setting menu 800.

The transforming unit 320 transforms the corresponding images by applying the display effect found by the searching unit 310, to the corresponding images according to a specified operation (S311). The display effect is not applied to pixel 900 data of the entire image, but may be applied through a predetermined set menu to the edge of the corresponding image or a background (outline) of the corresponding image with the image remaining in its original state.

When the transformed images are output, it is determined whether the mood category group 832 is set to an ON or OFF state (S321). If it is determined that the mood category group 832 is set to the ON state, images of the mood category group 832, to which the selected mood category 822 belongs, are gathered together and output on a screen by the outputting unit 330 (S331). The mood category group 832 may be set through a mood category group menu 830. The setting of the mood category group 832 will be described below with reference to FIG. 11.

If it is determined that the mood category group 832 is set to the OFF state, the outputting unit 330 outputs the images on the screen according to the mood category 822 selected by the user (S341).

FIGS. 8A and 8B illustrate a mood mode setting menu in accordance with yet another exemplary embodiment of the present invention.

As shown in FIG. 8A, it is possible for the user to set a mood mode through the mood mode setting menu 800. The mood mode setting menu 800 includes the mood flag menu 810 and the mood category menu 820.

The mood flag menu 810 is set to a value representing the ON/OFF state, as a result, it is possible to determine whether to apply a display effect to captured images. A value set through the mood flag menu 810 may be stored as a set value in the mood flag tag 410 of the mood information data 400.

The mood category menu 820 provides a category according to moods. A value set through the mood category menu 820 may be stored as a setting value of the mood category tag 420 in the mood information data 400. In addition, a display effect that matches the set value stored in the mood category tag 420 is found, and the predetermined display effect is applied to the corresponding images.

The mood category menu 820 may be configured to have contents in TABLE 1 as below.

TABLE 1

| | |
|---|---|
| joy | trouble |
| sorrow | humor |
| anger | vexation |
| pleasure | happiness |
| fear | reverence |
| love | fun |
| hatred | nothingness |
| worry | loneliness |

As shown in FIG. 8B, it is possible to provide the contents in TABLE 1 as the mood category 822. For example, when the user selects the item of joy 10 in the provided mood category 822, the joy 10 in the mood category 822 is stored as a setting value of the mood category tag 420 in the mood information data 400. Thereafter, a display effect that matches the joy 10 and is stored in the mood category tag 420, is found, and the display effect corresponding to the joy 10 is applied to the corresponding images.

FIG. 9 illustrates a method of applying a display effect to images in accordance with an exemplary embodiment of the present invention.

A display effect may include at least one of colors, brightness, chroma, and a combination thereof as a weight to be applied to a corresponding image. In addition, a weight may be merged with data of each pixel 900 of the corresponding image. For example, when a weight (α, β, and γ) corresponds to #fff00 (yellow), that is, an RGB value of a color, and a corresponding value represents joy 10, the weight may be merged with data of each pixel 900 of an image according to a predetermined operating (⊙) method.

When the weight is applied to data of each pixel 900 of the corresponding image, the application weight may be R′[i,j]=R[i,j]⊙α; G′[i,j]=G[i,j]⊙β; and B′[i,j]=B[i,j]⊙γ, where i and j are pixel coordinates Needless to say, the weight can be merged with data in units of inches or centimeters as well as the data in units of pixels 900. With the application of the display effect, the corresponding images are transformed into images in which moods are expressed.

In addition, the display effect may include filtering and background images. Filtering includes various effects such as sketch, sharpen, render, noise, invert, posterize, and the like. The background images may include predetermined images according to moods (e.g., a flame image with respect to anger).

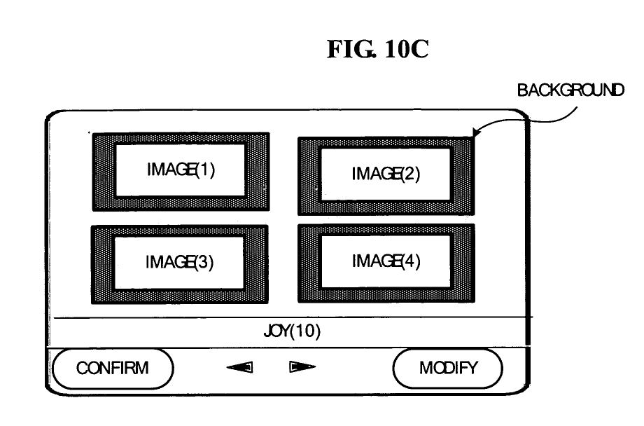

FIGS. 10A, 10B and 10C illustrate images being output according to a mood category in accordance with another exemplary embodiment of the present invention.

As shown in FIG. 10A, when images, to which the display effect is applied according to the mood mode, are output according to the mood category 822, if the user selects a desired mood category 822 (e.g., joy 10), all images, in which a setting value of the mood category tag 420 is set to the joy 10, are read, and a display effect corresponding to the joy 10 is applied to each of the images and images are output on the screen as shown in FIG. 10B.

In addition, as shown in FIG. 10C, the display effect can be applied to a background of each of the images. In this case, as shown in FIG. 9, the display effect is not applied to pixel 900 data of the entire image, but may be applied through a predetermined set menu to the edge of the corresponding image or a background (outline) of the corresponding image with the corresponding image remaining in its original state. For example, yellow (#ffff00), expressing the joy 10, may be applied to a background of an original image.

FIG. 11 illustrates a construction of a mood category group in accordance with still another exemplary embodiment of the present invention.

By setting the mood category group menu 830 (to the ON/OFF state), it is possible to gather together and output images of the mood category group 832, to which the mood category group 822, selected by the user, belongs, or to output images only corresponding to the mood category 822 selected by the user.

The mood category group 832 may be constructed as shown in FIG. 11A. For example, the mood category group 832 may include the joy 10, happiness 11 and fun 12, and another mood category group may include sorrow, trouble and anger. Accordingly, as shown in FIG. 10A, when the mood category 822 belongs to a mood category group 832, images of the corresponding group are gathered together and output on the screen. In addition, the mood category group 832 may be added or modified through adding/modifying 834.

As shown in FIG. 11B, for example, when the user selects the joy 10 through the mood category 822 as shown in FIG. 10A, the images, to which the joy 10 is applied, and images 13a, to which the happiness 11 and the fun 12 of the mood category group 832 are applied, are gathered together and output on the screen. Here, the selected mood category 822 belongs to the mood category group 832.

According to the apparatus and method for setting a mood mode and transforming images of the exemplary embodiments, the following advantages can be obtained.

First, it is possible to express moods in images.

Second, it is possible to output images according to a mood category on a screen.

Third, it is possible to gather together and output images of a mood category group, to which a mood category selected by a user belongs, on a screen.

Although the present invention has been described in connection with the exemplary embodiments of the present invention, it will be apparent to those skilled in the art that various modifications and changes may be made thereto without departing from the scope and spirit of the invention. Therefore, it should be understood that the above exemplary embodiments are not limitative, but illustrative in all aspects.

What is claimed is:

1. An apparatus for setting a mood mode, the apparatus comprising:
an image supplying unit which supplies images;
a setting unit which sets a mood mode for the supplied images; and
a storing unit which stores a setting value of the mood mode set by the setting unit as mood information data of each of the images.

2. The apparatus of claim 1, wherein the setting value of the mood mode comprises at least one of mood flag data and mood category data.

3. The apparatus of claim 2, wherein the mood information data is Exchangeable image file (Exif) information data in the form of meta data.

4. The apparatus of claim 1, wherein the setting unit sets the mood mode for the supplied images based on a user input via a mode setting menu.

5. The apparatus of claim 4, wherein the setting value of the mood mode comprises at least one of mood flag data and mood category data.

6. An apparatus for transforming images, the apparatus comprising:
a searching unit which determines a display effect according to a mood mode set for images;
a transforming unit which transforms the images according to the determined display effect; and
an outputting unit which outputs the transformed images.

7. The apparatus of claim 6, wherein each of the images comprises mood information data, the mood information data comprises a setting value of the mood mode, and the setting value of the mood mode comprises at least one of mood flag data and mood category data.

8. The apparatus of claim 7, wherein the mood information data is Exchangeable image file (Exif) information data in the form of meta data.

9. The apparatus of claim 7, wherein the display effect comprises at least one of colors, brightness, and chroma.

10. The apparatus of claim 7, wherein the display effect is merged with pixel data of the image.

11. The apparatus of claim 7, wherein the transformed images are output according to the mood category or images of a mood category group to which the mood category belongs are gathered together and output.

12. The apparatus of claim 7, wherein the searching unit determines the display effect by searching for the display affect that matches a mood category, among setting values of the mood mode set for the images.

13. The apparatus of claim 12, wherein the mood category is set by a user via a mode setting menu.

14. A method of setting a mood mode, the method comprising:
supplying images;
setting a mood mode for the supplied images; and
storing a setting value of the mood mode as mood information data of each of the images.

15. The method of claim 14, wherein the setting value of the mood mode comprises at least one of mood flag data and mood category data.

16. The method of claim 15, wherein the mood information data is Exchangeable image file (Exif) information data in the form of meta data.

17. The method of claim 14, wherein the setting the mood mode comprises setting the mood mode for the supplied images based on a user input via a mode setting menu.

18. The method of claim 17, wherein the setting value of the mood mode comprises at least one of mood flag data and mood category data.

19. A method of transforming images, the method comprising:
determining a display effect according to a mood mode set for images;
transforming the images according to the determined display effect; and
outputting the transformed images.

20. The method of claim 19, wherein each of the images comprises mood information data, the mood information data comprises a setting value of the mood mode, and the setting value of the mood mode comprises at least one of a mood flag data and a mood category data.

21. The method of claim 20, wherein the mood information data is Exchangeable image file (Exif) information data in the form of meta data.

22. The method of claim 20, wherein the display effect comprises at least one of colors, brightness, and chroma.

23. The method of claim 20, wherein the display effect is merged with pixel data of the image.

24. The method of claim 20, wherein the transformed images are output according to the mood category or images of a mood category group, to which the mood category belongs, are gathered together and output.

25. The method of claim 19, wherein the setting the mood mode comprises setting the mood mode for the supplied images based on a user input via a mode setting menu.

26. The method of claim 25, wherein the setting value of the mood mode comprises at least one of mood flag data and mood category data.
